(19) United States
(12) Patent Application Publication
(10) Pub. No.: US 2025/0045772 A1
(43) Pub. Date: Feb. 6, 2025

(54) DATA CENTER CARBON EFFICIENCY OPTIMIZATION

(71) Applicant: HEWLETT PACKARD ENTERPRISE DEVELOPMENT LP, Spring, TX (US)

(72) Inventors: Klaus-Dieter Lange, Houston, TX (US); Nishant Arun Rawtani, Bangalore (IN); Supriya Kamthania, Bangalore (IN)

(21) Appl. No.: 18/469,681

(22) Filed: Sep. 19, 2023

(30) Foreign Application Priority Data
Jul. 31, 2023 (IN) 202341051399

(51) Int. Cl. G06Q 30/018

(52) U.S. Cl. CPC G06Q 30/018

(57) ABSTRACT

Examples described herein relate to monitoring a carbon efficiency metric associated with a data center and determining a recommendation to improve the carbon efficiency metric. A data processing device may determine a carbon efficiency metric associated with a data center based on determining a power consumption of an infrastructure device of the data center. The data processing device may determine the carbon efficiency metric further based on estimating a performance of the infrastructure device based on the power consumption. The data processing device may also determine a recommendation to change the data center to improve the carbon efficiency metric based on predicting, using a machine learning model and based on a time-series dataset, whether the carbon efficiency metric is associated with a temporary event. The data processing device may provide the recommendation to an output device.

### BACKGROUND

The data center industry provides data storage and management, as well as the capacity to handle digital transactions. Data center resources, such as servers and storage devices, consume energy for operation and to deliver computational performance. Data centers also consume energy to keep these resources cool. For instance, a data center may consumer energy to cool air within the data center or to cool a liquid pumped through at least a portion of the data center.

### BRIEF DESCRIPTION OF THE DRAWINGS

These and other features, aspects, and advantages of the present specification will become better understood when the following detailed description is read with reference to the accompanying drawings in which like characters represent like parts throughout the drawings, wherein:

FIG. 1 depicts a system for monitoring and providing a recommendation to improve a carbon efficiency metric associated with a data center, in accordance with an example;

FIG. 2 depicts a recommendation to improve a carbon efficiency metric associated with a data center;

FIG. 3 is a flow diagram depicting a method for determining a recommendation to improve a carbon efficiency metric, in accordance with an example;

FIG. 4 is a flow diagram depicting a method for determining a carbon efficiency metric associated with a data center, in accordance with another example;

FIG. 5 is a flow diagram depicting a method for determining a recommendation to improve the carbon efficiency metric, in accordance with another example;

FIG. 6 is a flow diagram depicting a method for predicting whether the carbon efficiency metric is associated with a temporary event, in accordance with another example;

FIG. 7 is a flow diagram depicting a method for determining a recommendation to improve a future carbon efficiency metric, in accordance with another example;

FIG. 8 is a block diagram depicting a data processing device that includes a processor and a memory encoded with example instructions to monitor and provide a recommendation to improve a carbon efficiency metric associated with a data center, in accordance with an example; and

FIG. 9 is a block diagram depicting a computer-readable storage medium that includes instructions, in accordance with an example.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. It will also be understood that, although the terms first, second, third, fourth, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

Product carbon footprints (PCFs) represent the carbon emissions of a product over the life cycle of a product. Using the example of a server, this life cycle begins with the server's design, encompasses the use of the server, and ends with the disposal of the server. In some cases, the carbon emissions generated by the use of the server are approximated by estimating the amount of carbon that a server operating at a particular, static utilization (e.g., CPU and/or resource utilization) level (e.g., 30% utilization level) would emit. While such approximations can provide a general impression of the carbon emissions of a server, the actual carbon emissions of the server may vary widely based on the actual utilization levels of the server. For instance, a server operating at a lower utilization level is likely to operate with relatively low carbon efficiency, while a server running at 100% utilization is likely to operate with a higher carbon efficiency. Moreover, a server's utilization may vary throughout its life. This variation may be caused by changes in customer requirements. In addition, some workloads may not be suitable for running on a server with a utilization over a certain threshold due to technical limitations associated with the workload. Further, in some cases, servers may be operated below 100% utilization to reduce risk of hardware failure and increase the overall lifespan of the server.

As described herein, the term “carbon efficiency” relates to the use of less energy (or production of fewer carbon emissions) to produce the same result and may be used interchangeably with the term “energy efficiency.” In the context of data centers, carbon efficiency relates to the power consumption required to deliver a particular level of performance (e.g., operational and/or computational performance). A higher carbon efficiency corresponds to achieving a level of performance with a lower power consumption, while a lower carbon efficiency corresponds to achieving the same or a worse level of performance with a higher power consumption. Relatedly, the term “carbon efficiency metric” may refer to a value associated with performance of one or more devices in a data center, such as a measure of a device's performance or a ratio between the device's power consumption and performance. As described herein, the performance of a device may refer to the device's throughput (e.g., the number of operations the component is able to complete in a given interval divided by the duration of the interval).

Examples described herein relate to optimizing the carbon efficiency of a data center, and more specifically, monitoring a carbon efficiency metric associated with the data center as the data center is used (e.g., operated) and providing a recommendation of a change for the data center, such as substituting a component of the data center with alternative hardware, to improve the carbon efficiency metric. At a high level, to monitor the carbon efficiency metric associated with the data center, the power consumption of one or more devices (e.g., components) of the data center, such as servers, storage devices, and/or the like, may be collected. The performance of the devices may be estimated based on a mapping of power consumption and performance (e.g., based on a reverse look-up). The information for the mapping may be stored in a database and may use data such as Standard Performance Evaluation Corporation (SPEC) benchmark data. The database may also store operational data associated with one or more solutions (e.g., potential changes to the data center), which may include information on options available to reduce the energy consumed by the data center while maintaining or improving performance. For instance, this operational data associated with the solution may include power consumption, performance, and/or carbon efficiency information for alternative hardware solutions, such as a different generation server than a server currently in the data center, that may be used to replace the component. Based on determining that the carbon efficiency metric associated with the data center could be improved (e.g., based on identifying a solution that could improve the carbon efficiency metric), a recommendation may be provided at an output device, such as an electronic display device. This recommendation may advise substituting a component of the data center with alternative hardware, adding or removing hardware from the data center, or migrating workload to or from the component.

In some cases, a customer's carbon inefficient use of a data center may be temporary, and while a recommendation to improve the carbon efficiency of a data center may typically be appropriate when the data center reaches certain levels of inefficiency, such a recommendation may not be as practical or appropriate for temporary events. Using an e-commerce website as an example data center customer, the customer may see a spike of higher utilization of its website, and therefore the data center, during a holiday season. Using a social media website as an additional example of a data center customer, the customer may see a spike of higher utilization during the summer, when users are more likely to travel and post pictures. In either case, the spike may reduce the carbon efficiency of the data center during the relevant season, but after the season has passed, the data center may return to or move toward its previous carbon efficiency. As used herein, the terms “temporary” and “temporary event” may refer to a duration of limited nature, such as a 6-month period or less, a 3-month period or less, a month or less, a week or less, a day or less, and the like. In some cases, “temporary” may be less than a predefined duration, such as a duration indicated by a customer (e.g., within an SLA).

In some examples, recommendations that may otherwise be sent to a customer for carbon inefficiencies may be adjusted based on a determination that the carbon inefficiency (e.g., the carbon efficiency metric) is associated with a temporary event. In particular, whether a carbon inefficiency is lasting or temporary may be determined based on a time-series dataset. In this regard, time-series analysis may be used to determine whether a carbon efficiency metric is associated with a temporary event. Recommendations for inefficiencies (e.g., carbon efficiency metrics that can be improved) determined to be associated with a temporary event may be overridden. The time-series analysis may be performed using a time-series-based machine learning model. Overriding the recommendation may involve preventing a recommendation from being provided (e.g., not sending a recommendation). In some cases, prevention of providing recommendations may be implemented when no other alternative recommendations are available or may be implemented as a configurable setting such that customers receive fewer recommendations. As an alternative to overriding the recommendation, the recommendation may be adjusted to the temporary event use-case. For instance, a recommendation to purchase new hardware may not be well-suited for a temporary event because the timeline of purchasing and installing the hardware may surpass the duration of the event. Such a recommendation may be amended to an alternative recommendation, such as migrating a workload, if migration is available.

In some cases, the time-series dataset includes a trace of past carbon efficiency metrics of the data center over a period of time. Additionally or alternatively, the time-series dataset may include a trace of carbon efficiency metrics of a different data center, such as a data center for another customer or another data center utilized by the same customer. In this regard, a machine learning model may use historical data from the data center or from similar data centers to learn patterns of power consumption and/or carbon efficiencies. Based on this learning, the model may predict whether an event is temporary, which may correspond to a spike in power consumption for an e-commerce customer on a holiday weekend, or lasting, which may correspond to an increase in membership for a social media customer, for example.

Moreover, data centers that are currently satisfying desired carbon efficiency levels, which may be specified in a service level agreement (SLA), for example, may still become inefficient in the future. For instance, the growth of application traffic may alter power and/or performance requirements for the data center, which may impact the center's carbon efficiency. Accordingly, in some examples, future carbon inefficiencies (e.g., carbon efficiency metrics failing to satisfy a threshold) may be predicted in advance of when they occur, and a recommendation may be provided to a customer to make a change before the inefficiency is realized. As an illustrative example, a recommendation for the purchase of new hardware may be sent to a customer based on the prediction that the customer will begin operating with lower carbon efficiency. For instance, the recommendation may be provided based on a predicted future carbon efficiency metric falling below a threshold, such as a threshold efficiency level specified in the customer's SLA. By providing this recommendation in advance of a carbon inefficient operation state, the customer may implement changes, such as installing new hardware, that avoid the inefficiency or reduce the length of time the inefficiency lasts. The future carbon inefficiencies may be predicted using a time-series analysis, such as a time-series-based machine learning model.

The complexity of handling carbon efficiency in a data center is also heightened by the fact that data centers are often configured as heterogeneous environments. In this regard, data centers include a variety of different infrastructure devices, such as servers, storage devices, switches, and racks. Each of these infrastructure devices have respectively varying power utilization requirements and energy efficiencies, which depend on the device's configuration and usage. Like the example of a server operated at different utilization levels described above, different configurations and operation of the infrastructure devices may impact the carbon efficiencies of the devices. Further, even servers of the same generation and with the same processing capabilities may have different carbon efficiency profiles due to differences in their form factor (e.g., server height), cooling components (e.g., the absence, presence, or difference in performance of cooling components), and/or the like. For instance, a server with one rack unit of height (1U) may have a different carbon efficiency than a similar server with two rack units of height (2U).

Monitoring the carbon efficiency associated with the data center may thus involve monitoring a power consumption of one or more components of the data center and estimating a respective performance of each component. In this regard, in some examples, individual components of a data center may be monitored. Further, the database may include operational data for a wide variety of infrastructure devices and may include data for a wide variety of workload types, such as scientific workloads, virtualized workloads, deep learning workloads, Java workloads, and the like. The information included in the database may be prepopulated (e.g., at a development stage), manually updated (e.g., via manual upload of information), and/or automatically updated. For instance, data may be pulled from private or public repositories.

Further, in some examples, monitoring of carbon efficiency and/or recommendations may be provided at different levels of granularity. For instance, monitoring and/or recommendations may be made at the node, server, rack, container, data center level, or the like. In this regard, data from multiple components may be aggregated to determine carbon efficiencies at higher levels of abstraction and to provide recommendations at this level. In some examples, components of the data center may be tagged, and a hierarchy may be determined based on the tagging (e.g., based on levels of granularity of the tags). This hierarchy may be used for the aggregation of data and to provide recommendations at a desired level of granularity.

In some examples, the power consumption of one or more components of the data center may be collected via application program interfaces (APIs), such as representational state transfer (REST) or REDFISH® APIs, associated with the respective components via management software, for example. The power consumption data may be collected at a configurable rate. This rate may be set via a user setting. In some examples, the configurable rate may be automatically adjusted based on the carbon efficiency associated with the data center. For instance, the rate may be reduced to lower the energy consumption associated with the collection of data.

In some examples, a recommendation to add hardware or substitute hardware into a data center may be determined based on information, such as the capital and operational expense of the hardware, which may be stored in the database. For instance, such a recommendation may be provided when the operational cost reduction estimated to occur with the addition or substitution of the hardware offsets the capital expense of the hardware. The capital expense may include the cost of purchase and installation associated with the hardware. The operational cost reduction may encompass the difference in operational costs associated with operating the data center with and without the hardware. An operational cost reduction may be present when the power consumed by the hardware serving as a replacement is less than the power consumed by the hardware that is replaced. The operational costs may include the cost to cool the hardware, such as the cost of power consumed for cooling purposes.

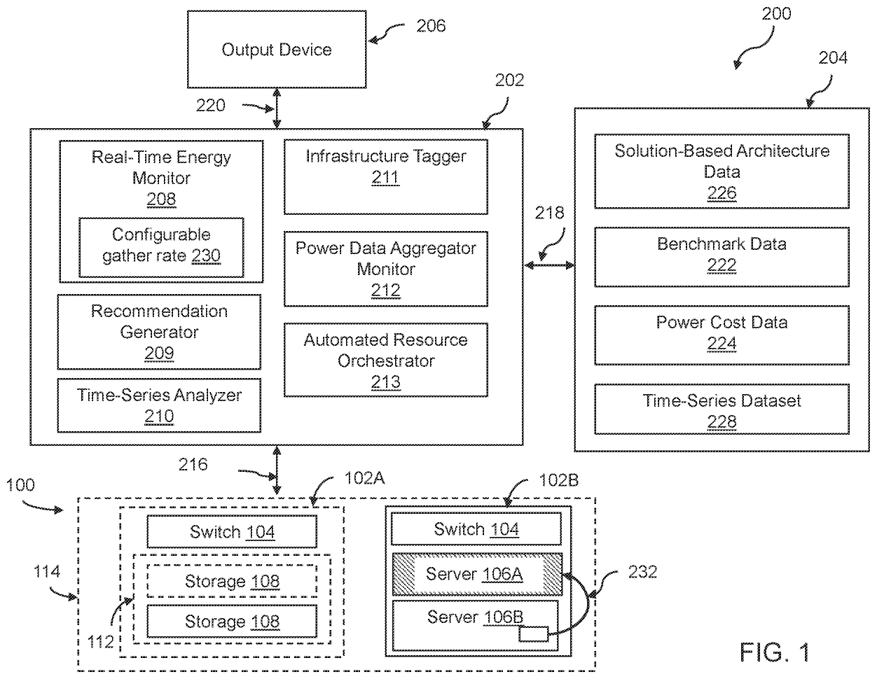

Referring now to the drawings, FIG. 1 depicts a system 200 for monitoring and providing a recommendation to improve a carbon efficiency metric associated with a data center 100. The system may include a data center 100, a data processing device 202, a database 204 (e.g., a memory), and an output device 206. While illustrated separately, the data processing device 202 may be included within the data center 100, such as within one or more infrastructure devices of the data center 100. For instance, the data processing device 202 may be a server 106, a group of servers, or the like. In some cases, the data processing device 202 may include a storage device 108. Moreover, the database 204 may be included within the data processing device 202, such as within a memory of the data processing device 202, or may be a separate component communicatively coupled to the data processing device 202. In some cases, the data processing device 202 and/or the database 204 may be separate devices (e.g., distinct from the data center 100), local, remote, and/or accessible via the cloud.

As represented by arrows 216, 218, and 220, components of the system 200 may be communicatively coupled. For instance, arrow 216 illustrates a communicative coupling between the data processing device 202 and the data center 100. Arrow 218 illustrates a communicative coupling between the data processing device 202 and the database 204, and arrow 220 illustrates a communicative coupling between the data processing device 202 and the output device 206. The communicative coupling represented by arrow 216, 218, and/or 220 may encompass a wired coupling, a wireless coupling (e.g., a network connection, a Bluetooth connection, or the like), or a combination thereof.

As described herein, the data center 100 may be used for data storage and/or management. For instance, a customer may use the data center 100 to host a website, process information, store information, or the like. As illustrated, the data center 100 may include a variety of infrastructure devices (e.g., components), such as a rack 102, a switch 104, a server 106, a storage device 108 (e.g., a hard drive, solid-sate drive (SSD), and/or the like), and/or the like used to host applications and store information. For instance, the data center 100 may include one or more racks, such as a first rack 102A and a second rack 102B. A rack 102 may house a switch 104, a server 106, a storage device 108, and/or the like. For simplicity, the data center 100 illustrated in FIG. 1 depicts infrastructure devices that may be present in a data center 100, such as a server 106, a storage device 108, a rack 102, and a switch 104, without reference to their arrangement within the data center 100. Moreover, while two racks 102, two switches 104, two storage devices 108, and two servers 106 are shown, it may be appreciated that the data center 100 may include any number or combination of such infrastructure devices.

As described herein, use of the data center 100 consumes power, which may contribute to the carbon emissions attributed to the operation of the data center 100. The power consumption of the data center 100 depends on the power consumption of its components, such as the servers 106, storage devices 108, and switches 104. The power consumption and carbon efficiency of these devices may vary based on the type and configuration of device. The configuration of a device may relate to the generation of the device, the components, such as processing components, included in the device, the form factor of the device (e.g., the server height of the device, the arrangement of the components within the device, or the like), cooling devices associated with the device, or the like. For instance, a server 106A with a first configuration may have different power consumption and carbon efficiency than a storage device 108 and a server 106B with a second configuration. The power consumption and carbon efficiency of these devices may further depend on how they are used. Using servers 106 as an illustrative example, a server 106 operating at a first level of utilization of its available processing resources (e.g., first utilization level or first level of utilization) may exhibit different power consumption and carbon efficiency than a server 106 operating on a second level of utilization. Servers 106 may operate at different levels of utilization for a variety of different reasons, such as workload requirements, changes in customer needs, or the like. For instance, servers 106 may vary in levels of utilization and/or power consumption based on hosting different workload types. Examples of different workload types include, but are not limited to, scientific workloads, Java workloads, virtualized workloads, deep learning workloads, database workloads, structured query language (SQL) workloads, online transaction processing (OLTP) workloads, decision support system (DSS) workloads, and other workloads. With each of the factors described above, the carbon efficiency of an infrastructure device and, as a result, of the data center 100 may fluctuate during operation.

Examples described herein relate to determining and improving a carbon efficiency metric associated with the data center 100. In some examples, power consumption and/or carbon efficiency metrics may be determined at different levels of granularity within the data center 100. For instance, the power consumption of an individual storage device 108 may be determined, or the collective power consumption of a grouping of infrastructure devices, such as a group of multiple storage devices 108 or the groupings described below with reference to the dashed box 112, rack 104A, and dashed box 114, may be determined. Determining carbon efficiency metrics at different levels of granularity may aid in illustrating the carbon efficiency of components of a heterogenous data center, such as the illustrated data center 100, as well as the overall carbon efficiency of the heterogenous data center.

Heterogenous data centers may include a variety of different infrastructure devices, such as different types of devices and/or different variations of a certain device. For instance, the illustrated data center 100 is heterogenous because it includes both servers 106 and storage devices 108, and the data center 100 is heterogeneous because the composition of devices included in the first rack 102A varies from the composition of devices included in the second rack 102B. The data center 100 is also heterogenous because it includes a server 106A with a first configuration and a server 106B with a different, second configuration. As an illustrative example, the server 106A with the first configuration may have a first server height, such as one rack unit of height (1U), while the server 106B with the second configuration may have a second server height, such as two rack units of height (2U). While depicted as a heterogeneous data center, examples are not limited thereto. Instead, the system may include a homogenous data center, which may include a single type of infrastructure device, for example.

At a high level, the data processing device 202 may monitor the power consumption of one or more components (e.g., infrastructure devices) of the data center 100. The data processing device 202 may determine, based on information in the database 204 and a carbon efficiency metric determined using the power consumption, a recommendation to improve the carbon efficiency metric. The data processing device 202 may implement and/or output the recommendation to the output device 206.

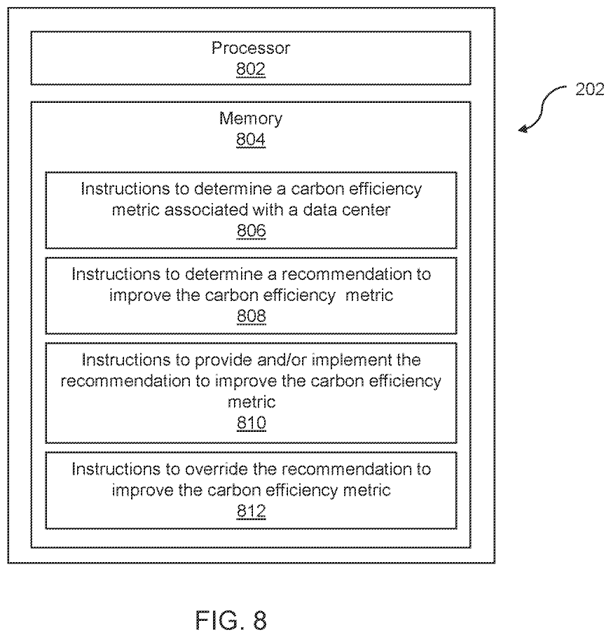

The data processing device 202 may include a real-time energy monitor 208, a recommendation generator 209, a time-series analyzer 210, an infrastructure tagger 211, a power data aggregator monitor 212, and an automated resource orchestrator 213. The data processing device 202 is illustrated as including functional blocks 208-213. The functional blocks 208-213 may be implemented as software (including executable computer program instructions stored on a computer-readable storage medium), hardware, or a combination of software and hardware. For instance, it may be appreciated that the functional blocks 208-213 may be implemented by a data processing device 202 having a processor and a memory, as described below with reference to FIG. 8.

The database 204 may include a variety of information, such as operational data 222, power cost data 224, solution-based architecture data 226, and time-series dataset 228. In general, the information stored in the database may be related to options available to reduce the energy consumed by the data center 100 while maintaining or improving the performance of the data center 100. For instance, the database 204 may include power consumption, performance, carbon efficiency metrics, cooling information, power costs, and/or the like for alternatives to a solution currently implemented in the data center. The information included in the database 204 may be prepopulated (e.g., at a development and/or database initialization stage), manually updated (e.g., via manual upload of information to the database 204), and/or automatically updated. For instance, data may be pulled (e.g., via a network connection) from private or public repositories. In some examples, the data stored in the database 204 may be stored in an intermediate format. For instance, the data processing device 202 may parse information pulled from a repository from a first format to a different, second format that requires less storage (e.g., fewer bits of information). That is, for example, the data processing device 202 may abstract the data into a more lightweight format. As an illustrative example, the data processing device 202 may encode a string of information into one or more bits representative of that information. In some examples, the data processing device 202 may use the second format directly or may reparse data from the database 204 into the first format.

To monitor the power consumption of one or more components of the data center 100, the real-time energy monitor 208 may gather power consumption data from the data center 100. In an example, the real-time energy monitor 208 may gather this data via an application program interface (API), such as a REST or REDFISH® API. The API may be available via a management software associated with (e.g., with access to) the infrastructure devices of the data center 100. In this regard, arrow 216 may further represent that the data processing device is communicatively coupled with the data center 100 via a software API.

In some examples, the data processing device 202 may independently monitor individual hardware components. For instance, the data processing device 202 may gather first power consumption data from a first server 106A of the data center, may gather second power consumption data from a second server 106B of the data center. In some cases, the data processing device 202 may gather power consumption data from each hardware device in the data center 100 or subset of the data center, such as within a rack 102 or set of racks 102.

In some examples, the real-time energy monitor 208 may gather the power consumption data while the data center 100 is in operation (e.g., while the data center's 100 are in used). In this regard, rather than determining a static estimate of a component's power consumption, the real-time energy monitor 208 may capture the power consumption of a data center component, such as a server 106, that corresponds to the server's current utilization and may dynamically update the power consumption as it changes. The real-time energy monitor 208 may gather the power consumption in real-time (e.g., on the order of milliseconds from when the power consumption data was created) or near real-time. The data processing device may gather the power consumption data at a configurable rate. This rate may be set via a user setting. In some examples, the configurable rate may be automatically adjusted based on the carbon efficiency associated with the data center. For instance, the rate may be reduced to lower the energy consumption associated with the collection of data.

The recommendation generator 209 may use the power consumption data gathered by the real-time energy monitor 208 to determine a carbon efficiency metric associated with the data center 100. In some examples, the carbon efficiency metric associated with the data center 100 may correspond to an individual component (e.g., infrastructure device) of the data center 100, such as an individual server 106, or a group of components of the data center 100. Using an individual component as an example, to determine the carbon efficiency metric, the recommendation generator 209 may estimate a performance of the component. The carbon efficiency metric may be a value associated with performance or may be a ratio between power utilization and performance. As described herein, the performance of the component may refer to the component's throughput (e.g., the number of operations the component is able to complete in a given interval divided by the duration of the interval). As a non-limiting, illustrative example, the performance may be characterized as operations per second. By estimating the performance of the component, the recommendation generator 209 may avoid accessing or profiling a customer's data, information, or application stored or running on the component. The recommendation generator may thus maintain the customer's privacy.

In some examples, the recommendation generator 209 may estimate the performance of a component based on the power consumption data gathered from the component. In particular, the recommendation generator 209 may estimate the performance based on a mapping (e.g., an operational or benchmark mapping) of power consumption and performance. The information for the mapping may be stored in the database 204 as operational data 222. The operational data 222 may include data such as Standard Performance Evaluation Corporation (SPEC) benchmark data. In general, the operational data 222 may include a respective mapping of performance to power at a utilization (e.g., load) level for each of a variety of infrastructure devices. The operational data 222 may include these mappings for the infrastructure devices a customer is currently using, such as those implemented in a data center 100, as well as for infrastructure devices that may be available for the customer to use, such as products available to the customer. Using the operational data 222, the recommendation generator 209 may, using a reverse-look up (e.g., mapping power to performance based on the mapping of performance to power), estimate a performance of a component that corresponds to the level of power consumption by the component.

In some examples, the operational data 222 may include data for a variety of different workloads, such as scientific workloads, Java workloads, virtualized workloads, deep learning workloads, database workloads, and the like. For instance, operational data 222 may include a SPEC CPU benchmark, a SPECpower_ssj benchmark, a SPECvirt benchmark, a MLperf benchmark, a TPC benchmark, and the like. The operational data 222 may thus map performance to power for a given workload, such as a Java workload. In some examples, the recommendation generator 209 may perform the reverse-look up further based on the workload of the component. The recommendation generator 209 may thus use the operational data 222 corresponding to a given workload to estimate, for a component handling the given workload at a certain level of power consumption, the likely performance of the component. The recommendation generator 209 may determine the workload of the component based on information from the customer (e.g., the customer's SLA) and/or information that may be gathered by the data processing device 202 (e.g., via the real-time energy monitor) that indicates how the component behaves. For instance, the data processing device may gather such information via the API described herein and/or via counters (e.g., counters for the CPU, storage, or the like) associated with the component.

In some examples, the recommendation generator 209 may estimate the performance of a component based on the power consumption data gathered from the component. In particular, the recommendation generator 209 may estimate the performance based on a mapping (e.g., an operational or benchmark mapping) of power consumption and performance. The information for the mapping may be stored in the database 204 as operational data 222. The operational data 222 may include data such as Standard Performance Evaluation Corporation (SPEC) benchmark data. In general, the operational data 222 may include a respective mapping of performance to power at a utilization (e.g., load) level for each of a variety of infrastructure devices. The operational data 222 may include these mappings for the infrastructure devices a customer is currently using, such as those implemented in a data center 100, as well as for infrastructure devices that may be available for the customer to use, such as products available to the customer. Using the operational data 222, the recommendation generator 209 may, using a reverse-look up (e.g., mapping power to performance based on the mapping of performance to power), estimate a performance of a component that corresponds to the level of power consumption by the component.

In some examples, the operational data 222 may include data for a variety of different workloads, such as scientific workloads, Java workloads, virtualized workloads, deep learning workloads, database workloads, and the like. For instance, operational data 222 may include a SPEC CPU benchmark, a SPECpower_ssj benchmark, a SPECvirt benchmark, a MLperf benchmark, a TPC benchmark, and the like. The operational data 222 may thus map performance to power for a given workload, such as a Java workload. In some examples, the recommendation generator 209 may perform the reverse-look up further based on the workload of the component. The recommendation generator 209 may thus use the operational data 222 corresponding to a given workload to estimate, for a component handling the given workload at a certain level of power consumption, the likely performance of the component. The recommendation generator 209 may determine the workload of the component based on information from the customer (e.g., the customer's SLA) and/or information that may be gathered by the data processing device 202 (e.g., via the real-time energy monitor) that indicates how the component behaves. For instance, the data processing device may gather such information via the API described herein and/or via counters (e.g., counters for the CPU, storage, or the like) associated with the component.

In some examples, the recommendation generator 209 may use the performance as a carbon efficiency metric. In some examples, the recommendation generator 209 may use the power consumption and the performance for a carbon efficiency metric. For instance, the carbon efficiency metric may be a ratio of power consumption and performance. Accordingly, the recommendation generator 209 may determine a carbon efficiency metric for a component based on the estimation of the performance of the component.

In some examples, the operational data 222 may be manually updated to include data, such as benchmarks. For instance, the operational data 222 may be manually provided to the database 204 (e.g., based on an input to the data processing device 202 and/or the database 204). In some examples, the data processing device 202 the data processing device 202 may automatedly pull information for the operational data 222 from a private or public repository (e.g., a public, online repository) via a network connection, for example. The data processing device 202 may update the operational data 222 on a regular interval (e.g., periodically) by pulling fresh data from the private or public repository, for example.

The recommendation generator 209 may also determine a recommendation to improve the carbon efficiency metric. A recommendation to improve the carbon efficiency metric may identify a solution (e.g., a change to the data center), such as substituting a component of the data center with alternative hardware, adding or removing hardware from the data center, migrating workload to or from the component (e.g., redistributing workload), and/or the like. The recommendation generator's 209 determination of the recommendation may be rule-based, and the recommendation generator 209 may use information from the database 204, such as the operational data 222. In this regard, the recommendation generator may determine the recommendation based on identifying a solution from the database 204 that satisfies a rule. An example rule is that a solution included in the recommendation achieves the same or better performance with reduced power (e.g., options having an improved carbon efficiency metric) as compared to the current component of the data center. In line with this rule, the recommendation generator 209 may identify that a first server 106 operating at a first carbon efficiency metric, should be replaced by a different, second server 106, such as a different model server, a newer generation server, and/or the like, that is able to operate at a greater, second carbon efficiency metric.

In the case of determining a recommendation based on a solution involving replacing a component, such as replacing a first component with a second component, the recommendation generator 209 may compare the carbon efficiency metric determined, as described above, for the first component with corresponding operational data 222 associated with the second component. For instance, the carbon efficiency metric of the first component may be compared to a carbon efficiency metric benchmarked for the second component for a corresponding workload, utilization load, or combination thereof. To that end, the recommendation generator 209 may determine, using the operational data 222, whether the second component can achieve the same or better performance at the same or lower power consumption than the first component.

In the case of determining a recommendation based on a solution involving migrating a workload (e.g., redistributing a workload) from a component, the recommendation generator 209 may compare the carbon efficiency metric determined for the first component with corresponding operational data 222 associated with the first component at an alternative utilization load. For instance, the carbon efficiency metric determined for the first component operating at a first level of utilization may be compared to a carbon efficiency metric benchmarked for the first component for a second level of utilization (e.g., a greater or lower level of utilization). To that end, the recommendation generator 209 may determine, using the operational data 222, whether the first component, when operating at the second level of utilization, can achieve the same or better performance at the same or lower power consumption than the first component when operating at the first level of utilization. In general, the carbon efficiency of a server that is underutilized (e.g., operating at too low of a utilization level) or overutilized (e.g., operating at too high of a utilization level) may be improved. In some cases, the recommendation generator 209 may further determine a recommendation to migrate a workload based on a customer's SLA. For instance, the recommendation generator 209 may evaluate whether a recommendation to migrate a workload is feasible given a customer's SLA. A recommendation to migrate a workload may be inappropriate (e.g., violate the SLA) of an SLA that requires virtual machines or containers to remain isolated, for example, while such a recommendation may comply with an SLA that lacks such a requirement. Information associated with the SLA may be stored in the database 204.

In some examples, the recommendation generator 209 may determine a recommendation involving a combination of solutions or recommendations. For instance, the recommendation generator 209 may recommend adding hardware (e.g., with or without removing hardware) in combination with migrating a workload. In this regard, the recommendation may identify that workload may be migrated to the new hardware, when added. As an illustrative example, the recommendation generator 209 may determine such a recommendation for a set of overutilized serves operating with a relatively low carbon efficiency metric. In this case, adding an additional server and migrating workload from the overutilized servers may improve the overall carbon efficiency of the data center. The recommendation generator 209 may recommend removing hardware (e.g., with or without adding hardware) in combination with migrating the workload from the removed hardware. As an illustrative example, the recommendation generator 209 may determine such a recommendation for an underutilized server. In this case, removing the underutilized server and migrating the workload from the underutilized server to other servers of the data center may improve the overall carbon efficiency of the data center.

In some examples, the recommendation generator 209 determines the recommendation if there is a solution (e.g., a change to the data center) satisfying the rule (e.g., a solution achieving the same or better performance with reduced power). For instance, the recommendation generator 209 may determine whether there is a solution, and responsive to determining there is a solution, may create a recommendation based on the solution. In some cases, the recommendation generator 209 determines the recommendation based on the carbon efficiency metric failing to satisfy a threshold, such as a predetermined threshold or a threshold indicated by a customer's SLA. For instance, responsive to the carbon efficiency metric being below a threshold, the recommendation generator determines the recommendation based on a solution satisfying the rule.

In some examples, the recommendation generator 209 determines a recommendation further based on a cost-benefit analysis, which may include consideration of capital expenses and operational expenses associated with a solution. The capital expenses may include the cost of purchase and/or installation associated with a solution, such as a hardware solution. The operating expenses include costs such as the fees for power consumed by the solution and for ancillary power, such as power required to cool the solution. Information associated with a solution's capital expenses and operational expenses may be stored in the database 204. The capital expense associated with a hardware device may be included in the solution-based architecture data 226. With respect to operating expenses, the recommendation generator 209 may use the power cost data 224, which may include a price charged per unit of power. The price per unit of power may correspond to a price for the geographical location (e.g., city, state, country) of the data center 100, such as an average price for the area or a price currently or previously charged at the data center 100. In some cases, the recommendation generator 209 may determine the operating expenses for a solution based on the price per unit of power included in the power cost data 224 and the benchmarked power consumption of the solution included in the operational data 222. For instance, the recommendation generator 209 may use this information to determine a cost for the power consumed by the solution over a time period, such as an hour, day, month, or the like.

The recommendation generator may further determine the operating expenses for the solution based on the price per unit of power included in the power cost data 224 and information associated with cooling a solution, such as the power consumption involved with running fans or pumping cooling fluids in the vicinity of the solution. The information associated with cooling a solution may be stored in the solution-based architecture data 226. As an illustrative example, in the case of a solution involving substituting a component with alternative hardware, such as substituting one server 106 in a rack 102 with another, the solution-based architecture data 226 may include information regarding the cooling capabilities associated with the rack 102, such as whether the rack is equipped with fans or cooling fluids and a power consumption of the rack's 102 cooling components. In this regard, the recommendation generator 209 may use the power cost data 224 and the solution-based architecture data 226 to determine a cost for cooling a solution over a time period, such as an hour, day, month, or the like.

In some examples, the recommendation generator 209 may provide a recommendation when an operational cost reduction estimated to be realized by a solution offsets the capital expense of the hardware. The operational cost reduction may encompass the difference in operational costs associated with operating the data center with and without the solution. An operational cost reduction may be present when the power consumed by a solution is less than the power consumed before the solution is implemented.

In addition to or as an alternative to determining a recommendation based on cost-benefit analysis, the recommendation generator 209 may take a customer's preferences and/or business use case into account. A customer's preference may indicate, for example, that improving a carbon efficiency metric and/or the carbon efficiency of the data center 100 takes priority over the cost associated with making such improvements. The recommendation generator 209 may, based on this preference, prioritize improving the carbon efficiency metric and/or the carbon over the cost associated with the improvement (e.g., prioritize over the cost-benefit analysis). As a result, the recommendation generator 209 may provide a recommendation in line with a customer's preferences. A customer's preferences may be provided in an SLA or may be provided via an input communicated to the data processing device 202, such as an input provided at the output device 206.

With an identified solution, the recommendation generator 209 may create a recommendation to be output to the output device 206. In some examples, the recommendation generator 209 generates a recommendation that, when output to the output device, causes the output device to display a text-based recommendation, such as a message to implement a solution. The recommendation may additionally or alternatively cause the output device to produce a sound, such as an audible recommendation, an alarm, or the like. In some cases, the recommendation may cause the output device to produce a visual element, such as turning on a light, or the like.

The output device 206 may be an electronic device, such as a computer, phone, or the like. The output device 206 may include an electronic display, a light, such as a light-emitting diode (LED), a speaker, or the like. In this regard, the output device 206 may be configured to display a recommendation, produce a visual element, such as turning on the light, in response to receiving a recommendation, produce a sound in response to receiving a recommendation, or the like. In some cases, the output device 206 may include a vibrational element, and the output device 206 may, using the vibrational element, vibrate in response to a recommendation.

While described as an output device, examples are not limited thereto. In this regard, the output device 206 may include or communicatively couple to an input device, such as a mouse, keyboard, touchscreen, or the like. An input from a customer may be received at such input devices and may be communicated to the data processing device 202. For instance, in some cases, a customer may provide an input to approve or disapprove of a recommendation, and the data processing device 202 may respectively implement or refrain from implementing a solution based on this input.

In some examples, the recommendation generator 209 may generate a recommendation that may be automatically implemented, for example, by the data processing device 202. As an illustrative example, responsive to the recommendation generator 209 determining that the carbon efficiency metric may be improved by migrating a workload, the data processing device 202 may implement (e.g., change the data center via) the workload migration. To that end, the data processing device 202 may be configured to instruct a component of the data center 100, such as a server 106, to offload workload to a different component of the data center 100. A visual representation of a workload migration 232 is illustrated as migrating a workload from server 106B to server 106A. In some examples, the data processing device 202 may implement a workload migration responsive to a customer's approval, which may be received via an input to the output device 206, for example.

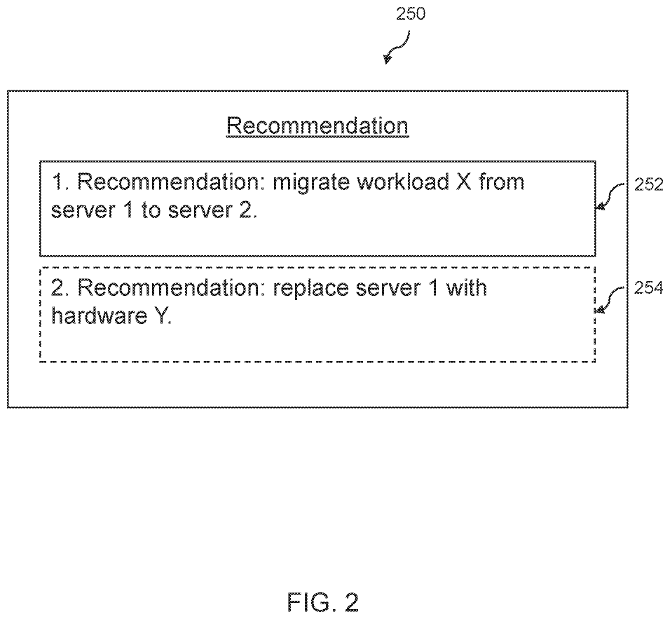

As described above, the recommendation generator 209 may determine a recommendation based on identifying a solution satisfying a rule. In some examples, the recommendation generator 209 may identify multiple different solutions that satisfy the rule. The recommendation generator 209 may combine these solutions into a single recommendation. In this regard, the recommendation may advise implementing multiple solutions. Additionally or alternatively, the recommendation generator 209 may prioritize the identified solutions. The recommendation generator 209 may base a priority of the solutions on a cost-benefit analysis (e.g., prioritizing solutions with greater cost-benefits), based on a customer's preference, which may be indicated in the SLA, based on an ease of implementation (e.g., prioritizing solutions that do not involve adding or removing hardware over those that do), or the like. The recommendation generator 209 may determine a recommendation based on a solution with the highest priority or may determine a recommendation that includes multiple solutions and includes an indication of their respective priorities. FIG. 2 illustrates an example of a prioritized recommendation 250 to improve a carbon efficiency metric associated with a data center. As illustrated, the prioritized recommendation may include a first recommendation 252 (e.g., based on a first solution) and a second recommendation 254 (e.g., based on a second solution) ordered based on their respective priority. The dashed border of the second recommendation 254 illustrates that the second recommendation 254 may be optional. In this regard, in some cases, the prioritized recommendation 250 may only include the first recommendation 252, which may correspond to a solution with the highest priority.

Further, while examples described herein relate generally to solutions impacting the components of the data center 100, the data processing device 202 may alter its own operations based on the recommendation generator 209. For instance, in response to the recommendation generator 209 determining that a carbon efficiency metric may be improved, the data processing device 202 may adjust the configurable gather rate 230 of the real-time energy monitor 208. The rate may be decreased to reduce the power consumed at the data processing device 202 to gather the data, for example. In some cases, the rate may be increased to better identify changes in power consumption and/or carbon efficiencies associated with the data center 100 as they occur. The data processing device 202 may further adjust the rate at which the data processing device updates the database 204. Reducing the rate at which the database 204 is updated may reduce the power consumed by the data processing device 202. In some examples, the data processing device 202 may additionally or alternatively update data in the database 204 on a more regular or less regular basis.

The time-series analyzer 210 may help the recommendation generator 209 to refine a recommendation determined by the recommendation generator 209. In particular, the time-series analyzer 210 may determine whether a carbon efficiency metric is associated with a temporary event (e.g., whether the data center 100 is experiencing a temporary event), and the recommendation generator 209 may determine a recommendation based on this determination. In a case where the time-series analyzer 210 determines that the carbon efficiency metric is associated with a temporary event, the recommendation generator 209 may prevent a recommendation from being provided (e.g., not send a recommendation) to the output device 206 or may tailor the recommendation for the temporary event use-case. For instance, a recommendation to add new hardware may not be well-suited for a temporary event because the timeline of purchasing and installing the hardware may surpass the duration of the event. The recommendation generator 209 may amend such a recommendation to an alternative recommendation, such as migrating a workload, if migration is available. Additionally or alternatively, the recommendation generator 209 may change a priority of a solution based on the time-series analyzer's 210 determination that an event is temporary. In some cases, the recommendation generator 209 may override a recommendation (e.g., prevent the recommendation from being sent) when no other alternative solutions are available. In some cases, the recommendation generator 209 may override a recommendation based on a configurable setting, such as a setting that may be set or adjusted by a customer, which may reduce the number of recommendations customers receive.

The time-series analyzer 210 may include a time-series-based machine learning model. Examples of such a machine learning model include a dynamic regression model, a long short-term memory (e.g., a type of recurrent neural network), an autoregressive-integrated-moving-average (ARIMA) model, and the like. At a high level, the time-series analyzer 210 may use a machine learning model to predict whether, without implementing any recommendations (e.g., adding hardware or migrating workload), a determined carbon efficiency metric will improve. In particular, the time-series analyzer 210 may use the machine learning model to predict whether there is a temporary event, such as a seasonal event (e.g., an event that occurs on a regular time interval) or an event with a limited duration (e.g., a 6-month period or less, a 3-month period or less, a month or less, a week or less, a day or less, or the like). In a simplified example, the machine learning model may make such a prediction based on what happened around the corresponding time in a previous interval (e.g., in the last year, quarter, month, or the like). As an additional example, the machine learning model may make such a prediction based on data (e.g., features) associated with the event, such as a change in power consumption of an infrastructure device or the data center, a rate of the change in power consumption of the infrastructure or the data center, or the like.

In some cases, the time-series analyzer 210 may use a time-series dataset 228. The time-series dataset 228 may include traces of data, such as power consumption, component utilization (e.g., resource and/or processing utilization) levels, measurements associated with the hardware or workload operation on a device, or carbon efficiency metrics, over time. The time-series dataset 228 may include this data at the granularity level of the data center 100, at the granularity level of an infrastructure device within the data center 100, or the like. Moreover, the time-series dataset 228 may include this data (e.g., traces) at the level of a specific customer, a group of customers, industry-wide, or the like. The time-series dataset 228 may include traces of the data described above gathered at regular (e.g., periodic) intervals and associated with a timestamp of the time the data was collected. As an illustrative example, a customer's data may be traced over a period of time, such as a year, and may be stored in the time-series dataset 228. The time-series dataset 228 may be collected via an API associated with (e.g., via management software) the respective infrastructure device the data is collected from. The time-series dataset 228 may include data at different levels of granularity, such as the levels of granularity described herein, and/or the time-series analyzer 210 may determine, using the time-series dataset 228, data at the different levels of granularity. In some examples, temporary events may additionally or alternatively be directly input to the time-series dataset 228. For instance, holidays, scheduled maintenance and/or downtime, and/or the like may be stored within the time-series dataset 228 as temporary events.

The time-series dataset 228 may be used to train the machine learning model. In this regard, the machine learning model may use traces (e.g., historical data) from the data center 100 or from similar data centers (e.g., data centers within the industry or corresponding to different customers) to learn patterns of power consumption and/or carbon efficiencies. Based on this learning, the model may predict whether an event is temporary, which may correspond to a spike in power consumption or carbon inefficiency, or lasting. The time-series analyzer 210 and/or the machine learning model may also take the directly input temporary events into account. For instance, the machine learning model may be trained so that the directly input temporary events are recognized as such, or the time-series analyzer 210 may override a prediction by the machine learning model that an event is lasting based on the directly input temporary events. In some cases, a model trained for one customer (e.g., trained on a time-series dataset for the customer) may be deployed for a different customer, such as a customer in the same industry or with similar data center requirements, to predict whether carbon efficiency metrics associated with the different customer are temporary.

In some cases, the time-series analyzer 210 may also predict whether a carbon efficiency metric associated with the data center 100 will fall below a threshold, such as a threshold specified in a customer's SLA, in the future. In some examples, the time-series analyzer 210 may make this prediction based on a certain duration (e.g., a quarter, 6 months, a year, or the like), such as a defined interval, determining whether the metric will fall below the threshold within or at the end of the duration. In some examples, the time-series analyzer 210 may predict when (e.g., a predicted date or time period) the carbon efficiency metric will fall below the threshold. Moreover, the time-series analyzer 210 may make predictions corresponding to different levels of granularity, such as the levels described herein. By making a prediction of whether and/or when a carbon efficiency metric will fall below a threshold, the data processing device 202 may make a recommendation to a customer to implement a change in advance of the carbon efficiency metric falling below the threshold.

The time-series analyzer 210 may use the time-series dataset 228 to make a prediction regarding the carbon efficiency metric in the future. For instance, the time-series analyzer 210 may make the prediction based on the trace of the customer's data, which may include workload and/or utilization data, power consumption data, carbon efficiency metric data, or the like, over time. In some cases, the time-series analyzer 210 may use a statistical model, such as a linear regression model, or a machine learning model to make the prediction. Using a linear regression model, for example, the time-series analyzer 210 may determine a line of best fit for a customer's data and use the line to predict future values of the customer's data, such as a future carbon efficiency metric. The machine learning model may be the same or a different model from the model used to determine whether an event is temporary. The machine learning model may be trained on the customer's data from the time-series dataset 228, and the trained model may be used to predict future values of the customer's data, such as a future carbon efficiency metric, to determine whether and/or when the metric will fall below a threshold. Using the above techniques, time-series analyzer 210 may predict a future carbon efficiency metric directly or may predict a future power consumption and future performance, which may then be used to determine the carbon efficiency metric.

To determine a recommendation for improving a future carbon efficiency metric (e.g., so that the future carbon efficiency metric satisfies the threshold), the recommendation generator 209 may use a similar technique as described above with the carbon efficiency metric determined based on the data from the real-time energy monitor 208 (e.g., a current carbon efficiency metric). Instead of using the measured power consumption, however, the recommendation generator 209 may use a power consumption predicted by the time-series analyzer 210. The recommendation generator 209 may then, using the operational data 222, determine a solution capable of delivering an improved carbon efficiency metric (e.g., capable of delivering the same or better performance with a lower power consumption) for a given level of granularity, and the recommendation generator 209 may output a recommendation based on this solution. The recommendation generator 209 may also conduct a cost-benefit analysis before outputting the recommendation.

While some of the examples described herein relate to monitoring the power consumption and providing recommendations for a specific component of a data center 100, examples are not limited thereto. Instead, in some examples, monitoring of carbon efficiency and/or recommendations may be provided at different levels of granularity. For instance, monitoring and/or recommendations may be made at the node, server, rack, container, data center level, or the like. For instance, a server 106 may be tagged at a first level of granularity, a rack may be tagged as a second level of granularity, a data center 100 may be tagged as a third level of granularity, and the like. Infrastructure tagger 211 may handle tagging components of the data center 100. As described herein, “tagging” a component of the data center 100 may refer to associating that component with a hierarchy or characteristic (e.g., a project, a business unit or department, a workload, or the like). In this regard, tagging a component may involve setting an attribute or field associated with the component in a management software. The infrastructure tagger 211 may tag components within the data center 100 based on an input from a customer. For instance, the customer may specify how to group components under common or differing tags. Additionally or alternatively, the infrastructure tagger 211 may automatically tag components based on a default tagging scheme, for example. A default tagging scheme may tag components at least on a per-device level. A visual example of tagging is shown in FIG. 1 using dashed lines.

More specifically, the dashed lines of the storage device 108 included in the rack 102A represent tagging of the storage device 108 at a first level of granularity, such as an individual device (e.g., component or resource) level. The dashed lines of the box 112 represent tagging of the two storage devices 108 together at a second level of granularity, such as a group of devices level. The dashed lines of rack 102A represent tagging each of the devices within the rack 102A (e.g., the switch 104 and the two storage devices 108) at a third level of granularity, such as a rack level. The dashed lines of the box 114 may represent tagging of each of the devices within the two racks 102A-B at a fourth level of granularity, such as a data center level. The infrastructure devices may be tagged via a data center management software.

The power data aggregator monitor 212 may further facilitate monitoring and/or evaluating the data center at different levels of granularity. As described herein, the real-time energy monitor may gather power data from individual components within the data center 100. The power data aggregator monitor 212 may aggregate the power data from these components according to the tagging implemented by the infrastructure tagger 211. Continuing with the example illustrated in FIG. 1, the power data aggregator 212 may aggregate the power data from the two storage devices 108 to create aggregated power data representative of the tagging represented by the box 112, the power data aggregator 212 may aggregate the power data from the each of the devices within the rack 102A to create aggregated power data representative of the tagging at the rack level for rack 102A, and the power data aggregator 212 may aggregate the power data from the each of the devices within the data center 100 to create aggregated power data representative of the tagging at the data center level for data center 100 (e.g., as represented by box 114).

In some examples, the recommendation generator 209 may determine recommendations at a granularity corresponding to the tagging and aggregated power data provided by the infrastructure tagger 211 and power data aggregator monitor 212, respectively. For instance, for rack-level tagging, the recommendation generator 209 may identify a solution at a corresponding, rack-level of granularity. More specifically, the recommendation generator 209 may identify an alternative rack, including the components such as the servers 106, switches 104, storage devices 108, or the like, contained within the rack, to replace an existing rack within the data center 100. The recommendation generator 209 may identify such a solution based on the operational data 222, the solution-based architecture data 226, or a combination thereof. For instance, in some examples, the solution-based architecture data 226 includes carbon efficiency data at different levels of granularity, including at a solution level. In this regard, the solution-based architecture 226 may include power consumption, performance, carbon efficiency metrics, and/or the like for a rack-based solution, and the recommendation generator 209 may use such information to compare a currently implemented rack in the data center 100 to an alternative rack that may be available to replace the implemented rack.

In some examples, the solution-based architecture data 226 may be manually updated to include information at solution-levels (e.g., at different levels of granularity). For instance, the data may be manually provided to the database 204. In some examples, the data processing device 202 may aggregate operational data 222 for components in a potential solution to construct the solution-based architecture data 226. The data processing device 202 may perform such operations in an automated fashion. Additionally or alternatively, the data processing device 202 may pull information for the solution-based architecture data 226 from a private or public repository via a network connection, for example.

In some cases, the automated resource orchestrator 213 handles resource orchestration for the data processing device 202. In this regard, the automated resource orchestrator 213 may handle interactions, such exchanging data, balancing computing resources, balancing power requirements, and the like, between the functional blocks 208-212.

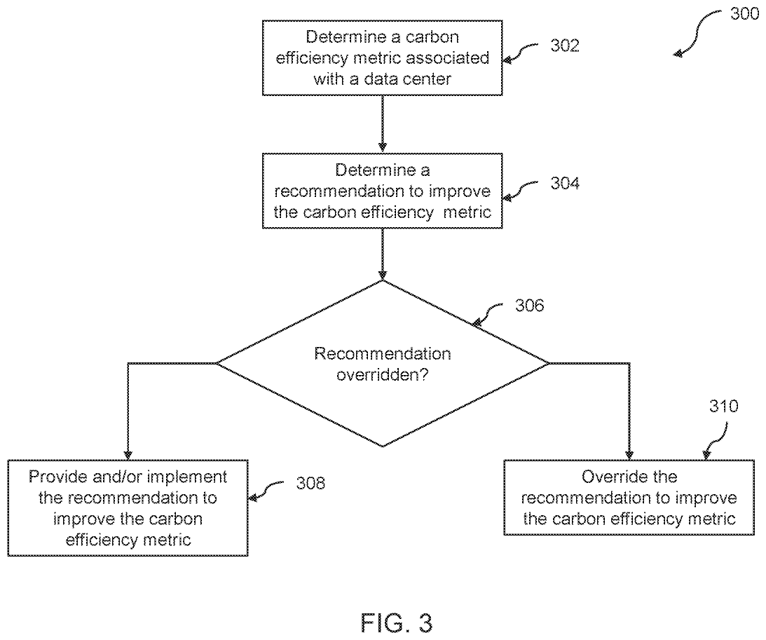

Referring now to FIG. 3, a flow diagram depicting a method 300 for determining a recommendation to improve a carbon efficiency metric is shown, in accordance with an example. For illustration purposes, the method 300 will be described in conjunction with the system 200 of FIG. 1. The method 300 may include method blocks 302, 304, 306, 308, and 310 (hereinafter collectively referred to as blocks 302-310) which may be performed by a processor-based system such as, for example, the data processing device 202. In particular, operations at each of the method blocks 302-310 may be performed by the data processing device 202 by executing the instructions stored in a machine-readable medium, as described below with reference to FIG. 8. Moreover, it is to be noted that in some examples, the order of execution of the blocks 302-310 may be different than that shown in FIG. 3. For example, blocks may be added or omitted, and the blocks 302-310 may be performed in series, in parallel, or a series-parallel combination.

At block 302, the data processing device 202 may determine a carbon efficiency metric associated with a data center, such as data center 100. The carbon efficiency metric may be representative of a carbon efficiency metric of a component or group of components within the data center 100. In this regard, the metric may be associated with a subset of infrastructure devices in the data center 100 or may be associated with each of the infrastructure devices in the data center 100. In some cases, the group or subset of infrastructure devices associated with the carbon efficiency metric may be identified by tagging, for instance, via the infrastructure tagger 211.

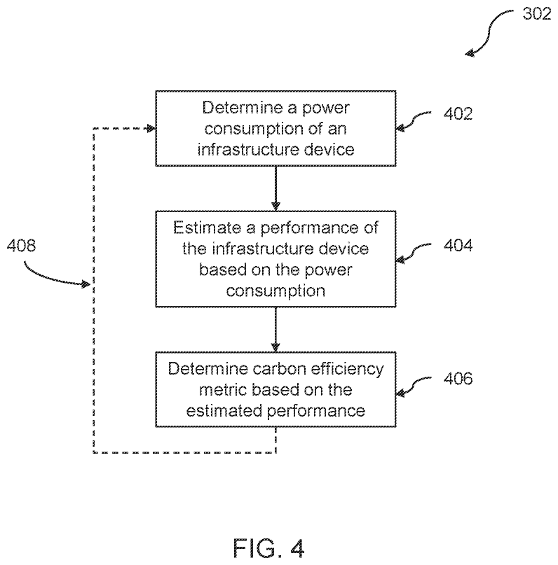

Turning to FIG. 4, a flow diagram depicting operations for determining a carbon efficiency metric associated with a data center, in accordance with an example of block 302 (FIG. 3), is shown. As described with reference to FIG. 3, the method blocks 402, 404, and 406 (hereinafter collectively referred to as blocks 402-406) may be performed by a processor-based system such as, for example, the data processing device 202. Further, it is to be noted that in some examples, the order of execution of the blocks 402-406 may be different than that shown in FIG. 4. For example, blocks may be added or omitted, and the blocks 402-406 may be performed in series, in parallel, or a series-parallel combination.

At block 402, the data processing device 202 may determine a power consumption of an infrastructure device. As described with reference to FIG. 1, the real-time energy monitor 208 of the data processing device 202 may determine the power consumption in real-time or near real time. The real-time energy monitor 208 may gather the power consumption data via an API associated with the infrastructure device. The real-time energy monitor 208 may gather the power consumption data according to a configurable gather rate 230, which may be set by a customer (e.g., via an SLA, via an input to the output device 206, or the like) or may be automatically adjusted by the data processing device 202.

At block 404, the data processing device 202 may estimate a performance of the infrastructure device based on the determined power consumption. As described with reference to FIG. 1, the recommendation generator 209 may estimate the performance based on the determined power consumption and data in the database 204, such as operational data 222, which may include a mapping of performance to power for infrastructure devices. Based on a reverse-look up of the operational data 222, the recommendation generator 209 may estimate a performance of the infrastructure device that corresponds to the level of power consumption by the device.

At block 406, the data processing device 202 may determine a carbon efficiency metric based on the estimated performance. In some examples, the recommendation generator 209 may determine the estimated performance to be the carbon efficiency metric. In some examples, the recommendation generator 209 may use the power consumption and the performance to determine the carbon efficiency metric. For instance, the recommendation generator 209 may determine the carbon efficiency metric by determining a ratio of the determined power consumption and the estimated performance.

In some cases, determining the carbon efficiency metric associated with the data center involves determining a carbon efficiency metric associated with a group of infrastructure devices, such as a group tagged by the infrastructure tagger 211. In some examples, determining the carbon efficiency metric associated with a group of infrastructure devices may involve repeating the operations associated with block 302, as illustrated by the arrow 408. The arrow 204 is indicated as optional by dashed lines. Operations may be repeated after a single step or within each step (e.g., repeating operations of block 404), repeated after performance of multiple steps (e.g., performing operations of block 402, block 404, and block 606 and then repeating the process), or a combination thereof. For instance, in some examples, determining the carbon efficiency metric associated with a group of infrastructure devices involves, at block 402, gathering, with the real-time energy monitor 208, the power consumption data for each device in the tagged group. Block 402 may also involve the power data aggregator monitor 212 aggregating the power consumption data gathered for each device in the tagged group.

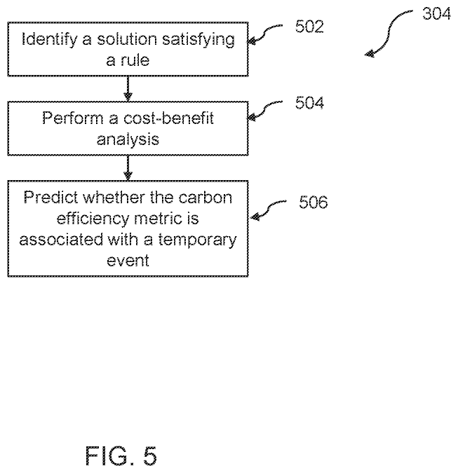

Returning now to FIG. 3, at block 304, the data processing device 202 may determine a recommendation to improve the carbon efficiency metric. In some examples, the data processing device 202 may determine the recommendation in accordance with the operations illustrated in FIG. 5. In some examples, the data processing device 202 performs the operations to determine the recommendation to improve the carbon efficiency metric in response to the carbon efficiency metric failing to satisfy a threshold. For instance, in response to the carbon efficiency metric falling below a threshold, such as a threshold indicated in a customer's SLA, the data processing device 202 may determine the recommendation, in accordance with block 304. In some examples, the data processing device 202 determines the recommendation without consideration of a threshold for the carbon efficiency metric.

Turning to FIG. 5, a flow diagram depicting operations for determining a recommendation to improve the carbon efficiency metric, in accordance with an example of block 304 (FIG. 3), is shown. The method blocks 502, 504, and 506 (hereinafter collectively referred to as blocks 502-506) may be performed by a processor-based system such as, for example, the data processing device 202. Further, it is to be noted that in some examples, the order of execution of the blocks 502-506 may be different than that shown in FIG. 5. For example, blocks may be added or omitted, and the blocks 502-506 may be performed in series, in parallel, or a series-parallel combination. More specifically, in some examples, operations associated with the blocks of FIG. 5 may be performed in response to a condition being satisfied, as described in greater detail below.

At block 502, the data processing device 202 may identify a solution satisfying a rule to determine the recommendation. The solution may involve migrating workload to or from an infrastructure device in the data center 100, adding an infrastructure device to the data center 100, removing an infrastructure device from the data center 100, and/or the like. In some examples, the rule for the solution to satisfy is that the solution achieves the same or better performance than the estimated performance with less power consumed than the determined power consumption. As described with respect to FIG. 1, the recommendation generator 209 of the data processing device 202 may identify solutions satisfying the rule (e.g., rule-based solutions) based on information in the database 204, such as operational data 222, solution-based architecture data 226, a customer's SLA, and/or the like. As further described herein, in some cases, the recommendation generator 209 may determine solutions for a recommendation at different levels of granularity, such as a granularity corresponding to the tagging and aggregated power data provided by the infrastructure tagger 211 and power data aggregator monitor 212, respectively.

In some cases, the recommendation generator 209 may override the recommendation in response to determining no solution satisfies the rule. As discussed in greater detail below, a recommendation that is overridden may be prevented from being output to the output device 206 or from being implemented. In some cases, the recommendation generator 209 may generate a recommendation advising a customer that no current solutions satisfy the rule.

At block 504, the data processing device 202 may perform a cost-benefit analysis to determine the recommendation. In some cases, the cost-benefit analysis may be performed at block 504 in response to a solution successfully being identified at block 502. To that end, a cost-benefit analysis may be performed responsive to the recommendation not being overridden at block 502.

In some cases, the recommendation generator 209 of the data processing device 202 may perform the cost-benefit analysis using the capital expenses and operational expenses associated with a solution identified at block 502. In particular, the recommendation generator 209 may determine, based on the solution-based architecture data 226 and the power cost data 224, whether an operational cost reduction estimated to be realized by the solution offsets a capital expense associated with implementing the solution. In some cases, performing the cost-benefit analysis may involve determining the recommendation based on the cooling costs associated with implementing a solution, which may be determined based on the power cost data 224, for example.

In some cases, the recommendation generator 209 may override the recommendation in response to determining that the costs of implementing a solution are outweighed by the benefits. For instance, the recommendation generator 209 may override the recommendation in response to determining the operational cost reduction does not offset the capital expense of the solution or does not offset by the capital expense by a certain margin (e.g., a flat or a percentage-based price difference). As discussed in greater detail below, a recommendation that is overridden may be prevented from being output to the output device 206 or from being implemented. In some cases, the recommendation generator 209 may generate a recommendation advising a customer that an identified solution failed the cost-benefit analysis.

At block 506, the data processing device 202 may predict whether the carbon efficiency metric is associated with a temporary event to determine the recommendation. A temporary event may be a seasonal event, an event of limited duration, a planned or scheduled event, such as a scheduled maintenance day, or the like.

In some cases, the prediction of whether the carbon efficiency metric is associated with a temporary event may be made at block 506 in response to a cost-benefit analysis where the benefits outweigh the costs (e.g., the operational cost reduction offsets the capital expenses). To that end, a cost-benefit analysis may be performed responsive to the recommendation not being overridden at block 504. In other cases, the data processing device 202 may make the prediction regardless of the result of the cost-benefit analysis performed at block 504.

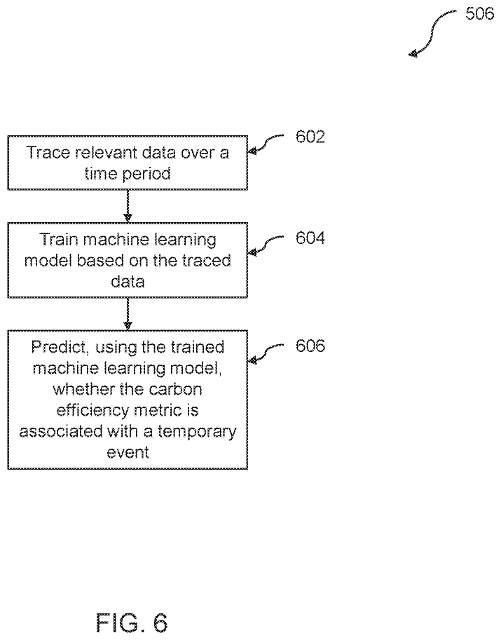

In some examples, the data processing device 202 may predict whether the carbon efficiency metric is associated with a temporary event based in accordance with the operations illustrated in FIG. 6.

Turning to FIG. 6, a flow diagram depicting operations for predicting whether the carbon efficiency metric is associated with a temporary event, in accordance with an example of block 506 (FIG. 5), is shown. The method blocks 602, 604, and 606 (hereinafter collectively referred to as blocks 602-606) may be performed by a processor-based system such as, for example, the data processing device 202. Further, it is to be noted that in some examples, the order of execution of the blocks 602-606 may be different than that shown in FIG. 6. For example, blocks may be added or omitted, and the blocks 602-606 may be performed in series, in parallel, or a series-parallel combination.

At block 602, the data processing device 202 may trace relevant data over a period of time (e.g., trace a time-series dataset). The relevant data may include power consumption, performance, component utilization (e.g., resource and/or processing utilization) levels, measurements associated with the hardware or workload operation on a device, or carbon efficiency metrics associated with one or more infrastructure devices in the data center 100. The relevant data may further include directly input temporary events, such as temporary events scheduled by the customer or a data center manager. For instance, in some cases, the relevant data may include a schedule or calendar of holidays. The relevant data may correspond to data from the data center 100 the recommendation is generated for (e.g., the customer's data center), data from another data center associated with the customer, data from a data center associated with another customer, data that is associated with an industry of the customer, or the like.

Tracing the data may involve tracking, using the time-series analyzer 210 of the data processing device, values of the relevant data over time. For instance, the time-series analyzer 210 may determine values of the relevant data after regular intervals over the period of time and may associate these values with a timestamp corresponding to when the value was determined. The period of time may be a few months, a year, multiple years, or the like. The time-series analyzer 210 may determine the values based on data collected manually from the device and input to the data processing device 202 and/or via an API associated with (e.g., via management software) the respective infrastructure device the data is collected from. In some examples, the time-series analyzer 210 may store traced data in the database 204 as a time-series dataset 228.

At block 604, the data processing device 202 may train a machine learning model based on the traced data. The machine learning model may be a dynamic regression model, a long short-term memory (e.g., a type of recurrent neural network), an autoregressive-integrated-moving-average (ARIMA) model, or the like. Training the machine learning model may involve providing the model with a first set of the traced data as a training set and providing a different, second set of the traced data to the model as a test set. Further, in some cases, a third set of the traced data may be used as a validation set for the model. Moreover, training the machine learning model may involve training the machine learning model to identify a discrete output based on the time-series dataset, such as an output indicating that an event is “temporary” or “lasting”, an output indicating that the question of whether an event is temporary is “true” or “false”, or the like. Additionally or alternatively, training the machine learning model may involve training the machine learning model to predict a value of relevant data, (including, but not limited to performance, power consumption, and/or carbon efficiency metric) following a temporary duration (e.g., after a few hours, days, weeks, months, and/or the like.) In some cases, the machine learning model may make the prediction based on a predefined duration, which a customer may indicate as “temporary.”

In some examples, a machine learning model may be trained for one data center or customer and may then be deployed for a different, similar data center or customer. For instance, a machine learning model trained on a time-series dataset 228 associated with a first customer may be used to make predictions for a second customer. The similar data center or customer may resemble the data center or customer for which the machine learning model was originally trained in that the similar one may include similar infrastructure devices, serve a similar purpose (e.g., operate in a similar industry), have similar requirements, or the like.

At block 606, the data processing device 202 may predict, using the trained machine learning model, whether the carbon efficiency metric is associated with a temporary event. In some examples, using the machine learning model may involve inputting data associated with the event, such as power consumption data, performance data, carbon efficiency metric data, or the like associated with one or more infrastructure devices in the data center 100. Date information (e.g., the time of year) may also be provided to the machine learning model for the prediction. In some examples the information input to the machine learning model may be stored in the time-series dataset 228 as data that the machine learning model was not trained on. In some examples, the trained machine learning model may provide an output indicating whether an event is temporary (e.g., an output indicating “temporary” or “lasting,” an output indicating that the question of whether an event is temporary is “true” or “false,” or the like.). In some examples, the trained machine learning model may provide a prediction of a future a performance, power consumption, and/or carbon efficiency metric following a temporary duration, such as a predefined duration indicated by a customer as “temporary”, and the data processing device 202 may determine that an event was temporary based on the predicted value being lower (e.g., less) than the corresponding current value.

In some examples, the recommendation generator 209 may override the recommendation in response to determining the carbon efficiency metric is associated with a temporary event. For instance, the recommendation generator 209 may determine that a solution is not worth (e.g., not practically worth, or feasible, not worth with respect to cost-benefit analysis, or the like) implementing in this case because the carbon efficiency metric may improve when the event ends, regardless of whether the solution is implemented. Accordingly, the recommendation generator 209 may prevent the recommendation from being output to the output device 206 or from being implemented.

Alternatively, in response to determining the carbon efficiency metric is associated with a temporary event, the recommendation generator 209 may generate a recommendation advising a customer that the carbon efficiency metric is associated with a temporary event. Additionally or alternatively, the recommendation generator 209 may adjust the recommendation output to the output device 206 based on the prediction. For instance, as described below, the recommendation generator 209 may adjust a prioritization of identified solutions in cases where multiple solutions are identified at block 502.

In some cases, the recommendation generator 209 may override a recommendation (e.g., prevent the recommendation from being sent) when a single solution was identified that will not be practicable during the temporary event (e.g., installing new hardware) and no other alternative solutions are available. In some cases, the recommendation generator 209 may override a recommendation based on a configurable setting, such as a setting that may be set or adjusted by a customer, which may reduce the number of recommendations customers receive. For instance, a customer may set the setting so that no recommendations are provided for temporary events.

In some examples, the block 602 and the block 604 may be performed as part of an initialization of the machine learning model, and once the machine learning model is initialized, predicting whether the carbon efficiency metric is associated with a temporary event at block 506 of FIG. 5 may involve predicting, using the trained machine learning model, whether the carbon efficiency metric is associated with a temporary event at block 606. In other examples, the machine learning model may be continuously trained and/or retrained on traced data. In this regard, the time-series analyzer 210 may continue to trace relevant data from a data center 100 as it is operated and may thus update the time-series dataset 228 with more current data over time. The time-series analyzer 210 may further retrain, at block 604, the machine learning model using the most up-to-date traced data in the time-series dataset 228. Accordingly, the predictions of the machine learning model may be continually (e.g., iteratively) refined.

Turning back to FIG. 5, while not illustrated, the operations for determining a recommendation may further involve determining a priority of solutions when multiple solutions are identified at block 502. The priority may be determined at any combination of the blocks 502-506. In some examples, block 502 may involve determining a priority of identified solutions based on, for example, a customer's preference (e.g., SLA preferences), an ease of implementation of the solution (e.g., prioritizing solutions that do not involve adding or removing hardware over those that do), the expected carbon efficiency metric and/or performance to power ratio of the solution (e.g., prioritizing solutions expected to deliver the greatest performance at the lowest power), or the like. The recommendation generator 209 may determine the recommendation based on a solution with the highest priority or may determine the solution based on the prioritized list of solutions (e.g., recommending each of the solutions in a ranked order based on priority).

Additionally or alternatively, the recommendation generator 209 may determine the prioritization of identified solutions based on the cost-based analysis of block 504. For instance, the recommendation generator 209 may prioritize solutions with greater offsets of capital expenses by operational cost reduction over those with lower offsets. In some examples, the identified solutions are not prioritized at block 502 but are prioritized at block 504 (e.g., based on cost-benefit analysis). In other examples, the identified solutions may be prioritized at block 502, and the prioritization may be adjusted at block 504.

The recommendation generator 209 may also determine the prioritization of identified solutions based on the prediction of block 506. For instance, based on a prediction that the carbon efficiency metric is associated with a temporary event, the recommendation generator 209 may prioritize solutions that may be implemented more rapidly over others, such as prioritizing migrating a workload over adding or removing hardware. Based on a prediction that the carbon efficiency metric is not associated with a temporary event, the recommendation generator 209 may prioritize the solutions in accordance with the techniques described above with reference to blocks 502 and 504. To that end, in some examples, the solutions are not prioritized at block 502 and/or block 504 but are prioritized at block 506. In other examples, the identified solutions may be prioritized at block 502 and/or block 504, and the prioritization may be adjusted at block 506.

Returning now to FIG. 3, at block 306, the data processing device 202 may determine whether the determined recommendation has been overridden. As described above, the recommendation generator 209 may override the recommendation in response to determining that no solution satisfies the rule at block 502, in response to determining the costs of implementing a solution are outweighed by the benefits, in response to determining the carbon efficiency metric is associated with a temporary event, and/or the like. If, at block 306, the data processing device 202 determines that the recommendation was not overridden, the data processing device 202 may proceed to providing and/or implementing the recommendation at block 308. If, on the other hand, the data processing device 202 determines that the recommendation was overridden, the data processing device 202 may proceed with overriding the recommendation at block 310.

At block 308, the data processing device 202 may provide the recommendation by providing the recommendation to the output device 206. In some examples, the recommendation generator 209 may determine (e.g., at block 304) a recommendation that, when provided to the output device 206, causes the output device 206 to produce a visual element (e.g., display a message, flash a light, or the like), an audio element (e.g., produce a sound or alarm), or a combination thereof.

In some cases, the recommendation generator 209 may determine (e.g., at block 304) a recommendation that may be automatically implemented by the data processing device 202, for example. The data processing device 202 may thus, responsive to the determination of the recommendation, implement the recommendation by adjusting operation of the data processing device 202 itself or of an infrastructure device of the data center 100. For instance, the data processing device 202 may adjust the gather rate of the real-time energy monitor 208, adjust the frequency with which data in the database 204 is updated, and/or the like in response to the recommendation. Additionally or alternatively, the data processing device 202 may implement a recommendation that does not require physical intervention in the data center 100. As an illustrative example, responsive to the recommendation generator 209 determining that the carbon efficiency metric by migrating a workload, the data processing device 202 may implement the workload migration. To that end, the data processing device 202 may be configured to instruct a component of the data center 100, such as a server 106, to offload workload to a different component of the data center 100. In some examples, the data processing device 202 may implement a recommendation, such as a recommendation for workload migration, responsive to a customer's approval, which may be received via an input to the output device 206, for example.

At block 310, the data processing device 202 may override the recommendation. As described herein, overriding the recommendation may involve preventing the recommendation from being provided to the output device 206. The data processing device 202 may also prevent the recommendation from being implemented at the data processing device 202.

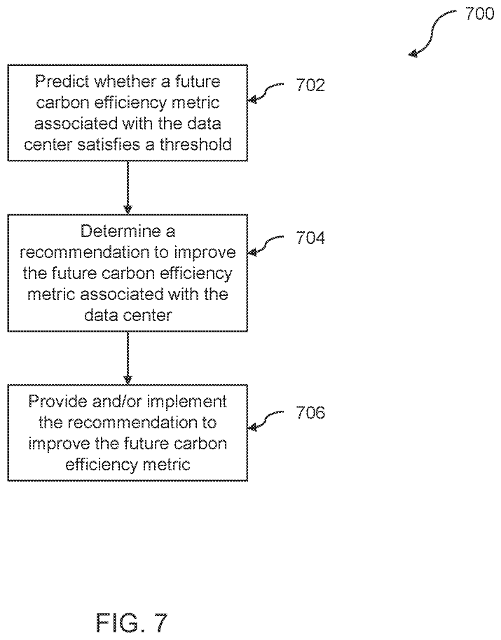

Referring now to FIG. 7, a flow diagram depicting a method 700 for determining a recommendation to improve a future carbon efficiency metric is shown, in accordance with an example. For illustration purposes, the method 700 will be described in conjunction with the system 200 of FIG. 1. The method 700 may include method blocks 702, 704, and 706 (hereinafter collectively referred to as blocks 702-706) which may be performed by a processor-based system such as, for example, the data processing device 202. In particular, operations at each of the method blocks 702-706 may be performed by the data processing device 202 by executing the instructions stored in a machine-readable medium, as described below with reference to FIG. 8. Moreover, it is to be noted that in some examples, the order of execution of the blocks 702-706 may be different than that shown in FIG. 7. For example, blocks may be added or omitted, and the blocks 702-706 may be performed in series, in parallel, or a series-parallel combination.

At block 702, the data processing device 202 may predict whether a future carbon efficiency metric associated with the data center satisfies a threshold. The data processing device 202 may make this prediction for a set duration from a current date. For instance, the data processing device 202 may predict whether the carbon efficiency metric in six months, a year, two years, or the like from the present time will satisfy the threshold. The data processing device 202 may make the prediction based on a predefined duration, which may be indicated by the customer (e.g., in an SLA). The data processing device 202 may predict the carbon efficiency metric corresponding to a future date and may determine whether the predicted future carbon efficiency metric satisfies the threshold. Additionally or alternatively, the data processing device 202 may predict when (e.g., a predicted date or time period) the future carbon efficiency metric will fall below the threshold. In this case, the data processing device 202 will predict that the future carbon efficiency metric will fail to satisfy the threshold and may determine when this failure may occur.

To make such predictions, the data processing device 202 may employ operations similar to those described at block 602 and block 604 of FIG. 6. More specifically, the data processing device 202 may trace relevant data over time and may train a machine learning model based on the traced data. The data traced to make the prediction regarding the future carbon efficiency metric may be the same or different from the data traced to predict whether the carbon efficiency metric is associated with a temporary event. In some examples, the data processing device 202 may trace power consumption data, carbon efficiency metrics, workload and/or utilization data, data associated with a customer's requirements, such as application requirements, or the like over time and may store the traced data as part of the time-series dataset 228.

In some cases, the time-series analyzer 210 of the data processing device 202 may use a statistical model, such as a linear regression model, or a machine learning model, such as a neural network, to make the prediction. The machine learning model may be the same or a different model from the model used to determine whether an event is temporary. The machine learning model may be trained on the traced data in the time-series dataset 228, and the trained model may be used to make predictions regarding the future carbon efficiency metric. In some examples, the machine learning model may be trained for a first customer or data center (e.g., a pre-trained model) and may then be employed for a different, second customer or data center.

At block 704, the data processing device 202 may determine a recommendation to improve the future carbon efficiency metric associated with the data center. In some examples, the data processing device 202 may perform the operations associated with block 704 in response to predicting that the future carbon efficiency metric failing to satisfy the threshold, such as a threshold indicated in a customer's SLA.

To determine the recommendation, the data processing device 202 may employ operations similar to those described at block 502 and block 504 of FIG. 5. More specifically, the data processing device 202 may identify a solution satisfying a rule. The data processing device 202 may also perform a cost-benefit analysis for an identified solution. In identifying a solution, the data processing device 202 may determine whether there are any solutions that deliver the same or better performance at a lower power consumption, each as compared to the expected values associated with the future carbon efficiency metric. That is, for example, the data processing device 202 may identify a solution with an improved carbon efficiency metric compared to the future carbon efficiency metric. The data processing device 202 may perform a cost-benefit analysis on the identified solution, as similarly described with reference to block 504 of FIG. 5. In some examples, the data processing device 202 may override the recommendation for improving the future carbon efficiency metric responsive to failing to identify a solution or responsive to the costs outweighing the benefits in the cost-benefit analysis.

At block 706, the data processing device 202 may provide and/or implement the recommendation to improve the future carbon efficiency metric. The data processing device 202 may provide the recommendation to improve the future carbon efficiency metric by providing the recommendation to the output device 206, as similarly described above with respect to block 308 of FIG. 3. Further, in some examples, the data processing device 202 may, responsive to the determination of the recommendation (e.g., at block 704), implement the recommendation by adjusting operation of the data processing device 202 itself or of an infrastructure device of the data center 100, as similarly described above with respect to block 308 of FIG. 3. The data processing device 202 may provide and/or implement the recommendation responsive to determining the recommendation was not overridden.

While the method 700 is illustrated separately from the method 300 of FIG. 3, it may be appreciated that the two methods may be combined. For instance, in some examples, the operations of blocks 702-706 may follow block 308 and/or block 310 of method 300. More specifically, responsive to overriding the recommendation to improve the carbon efficiency metric, at block 302, the data processing device 202 may proceed to perform the method 700 (e.g., proceed to predicting, at block 702, whether the future carbon efficiency metric will satisfy the threshold). Additionally or alternatively, the data processing device 202 may proceed to perform the method 700 responsive to providing and/or implementing the recommendation to improve the carbon efficiency metric. Moreover, in some examples, the operations of method 300 and method 700 may be combined. In such cases, a single output may be provided to the output device 206, and this output may include a recommendation to improve the carbon efficiency metric (e.g., the current carbon efficiency metric) and a recommendation to improve a future carbon efficiency metric, which may be the same or different from the recommendation for the current carbon efficiency metric.

Moving to FIG. 8, a block diagram 800 depicting a data processing device 202 that includes a processor 802 and a memory 804 having example instructions to facilitate the operations described herein is shown, in accordance with an example. The memory 804 may be a machine-readable medium, may be non-transitory, and may be alternatively referred to as a non-transitory machine-readable medium 804. In some examples, the memory 804 may be accessed by the processor 802.

The memory 804 may be any electronic, magnetic, optical, or other physical storage device that may store data and/or executable instructions. Therefore, the memory 804 may be, for example, RAM, an EEPROM, a storage drive, a flash memory, a CD-ROM, and the like. As described in detail herein, the memory 804 may be encoded with executable instructions 806, 808, 810, and 812 (hereinafter collectively referred to as instructions 806-812) for performing the method 300 described in FIG. 3. Although not shown, in some examples, the memory 804 may be encoded with certain additional executable instructions to perform the operations of block 302, including blocks 402-406 illustrated in FIG. 4, the operations of block 304, including blocks 502-506 illustrated in FIG. 5, the operations of block 506, including blocks 602-606 illustrated in FIG. 6, the method 700 described in FIG. 7, and/or any other operations performed by the data processing device 202, without limiting the scope of the present disclosure. For instance, in some examples, the memory 804 may be encoded with executable instructions to implement the methods described herein using the functional blocks 208-213 illustrated in FIG. 1. Further, memory 804 may include information, such as operational data 222, power cost data 224, solution-based architecture data 226, and/or time-series data set 228, illustrated as being stored in the database 204 in FIG. 1.

The processor 802 may be a physical device, for example, one or more central processing unit (CPU), one or more semiconductor-based microprocessor, one or more graphics processing unit (GPU), application-specific integrated circuit (ASIC), field programmable gate array (FPGA), other hardware devices capable of retrieving and executing the instructions 806-812 stored in the memory 804, or combinations thereof. In some examples, the processor 802 may fetch, decode, and execute the instructions 806-812 stored in the memory 804 to determine a recommendation to improve a carbon efficiency metric associated with a data center 100. In certain examples, as an alternative or in addition to retrieving and executing the instructions 806-812, the processor 802 may include at least one integrated circuit (IC), other control logic, other electronic circuits, or combinations thereof that include a number of electronic components for performing the functionalities intended to be performed by the data processing device 202 of FIG. 1.

The instructions 806, when executed by the processor 802, may cause the processor 802 to determine a carbon efficiency metric associated with a data center 100. Further, the instructions 808, when executed by the processor 802, may cause the processor 802 to determine a recommendation to improve the carbon efficiency metric. The instructions 810, when executed by the processor 802, may cause the processor 802 to provide and/or implement the recommendation to improve the carbon efficiency. The instructions 812, when executed by the processor 802, may cause the processor 802 to override the recommendation to improve the carbon efficiency metric.

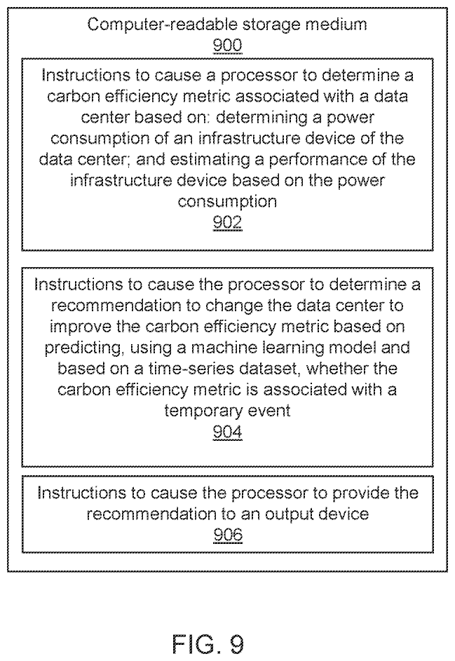

Moving to FIG. 9, a block diagram depicting a computer-readable storage medium 900 having example instructions to facilitate the operations described herein is shown, in accordance with an example. The computer-readable storage medium may be non-transitory and may be alternatively referred to as a non-transitory machine-readable medium 900.

The computer-readable storage medium 900 may be any electronic, magnetic, optical, or other physical storage device that may store data and/or executable instructions. Therefore, the computer-readable storage medium 900 may be, for example, RAM, an EEPROM, a storage drive, a flash memory, a CD-ROM, and the like. As described in detail herein, the computer-readable storage medium 900 may be encoded with executable instructions 902, 904, and 906 (hereinafter collectively referred to as instructions 902-906). While instructions 902, 904, and 906 are illustrated, it may be appreciated that in some examples, instructions may be omitted, added, and/or combined. Although not shown, in some examples, the computer-readable storage medium 900 may be encoded with certain executable instructions to perform the operations for performing the method 300 described in FIG. 3, including blocks 402-406 illustrated in FIG. 4, including blocks 502-506 illustrated in FIG. 5, including blocks 602-606 illustrated in FIG. 6, the method 700 described in FIG. 7, and/or any other operations performed by the data processing device 202, without limiting the scope of the present disclosure. For instance, in some examples, the computer-readable storage medium 900 may be encoded with executable instructions to implement the methods described herein using the functional blocks 208-213 illustrated in FIG. 1. Further, computer-readable storage medium 900 may include information, such as operational data 222, power cost data 224, solution-based architecture data 226, and/or time-series data set 228, illustrated as being stored in the database 204 in FIG. 1.

The instructions 902 may include instructions to (when executed by a processor) cause a processor to determine a carbon efficiency metric associated with a data center based on: determining a power consumption of an infrastructure device of the data center; and estimating a performance of the infrastructure device based on the power consumption. The instructions 904 may include instructions to (when executed by a processor) cause the processor to determine a recommendation to change the data center to improve the carbon efficiency metric based on predicting, using a machine learning model and based on a time-series dataset, whether the carbon efficiency metric is associated with a temporary event. The instructions 906 may include instructions to (when executed by a processor) cause the processor to provide the recommendation to an output device.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed is:

1. A non-transitory computer-readable storage medium having stored thereon executable computer program instructions that, when executed by a processor, cause the processor to:
determine a carbon efficiency metric associated with a data center based on:
determining a power consumption of an infrastructure device of the data center; and
estimating a performance of the infrastructure device based on the power consumption;
determine a recommendation to change the data center to improve the carbon efficiency metric based on predicting, using a machine learning model and based on a time-series dataset, whether the carbon efficiency metric is associated with a temporary event; and
provide the recommendation to an output device.

2. The non-transitory computer-readable storage medium of claim 1, wherein the executable computer program instructions, when executed by the processor, further cause the processor to:
implement the change to the data center based on the recommendation, wherein the change comprises migrating a workload of the data center.

3. The non-transitory computer-readable storage medium of claim 1, wherein the executable computer program instructions, when executed by the processor, cause the processor, to determine the power consumption of the infrastructure device, to:
gather, at a configurable gather rate, power consumption data from the infrastructure device.

4. The non-transitory computer-readable storage medium of claim 1, wherein the executable computer program instructions, when executed by the processor, cause the processor, to determine the carbon efficiency metric associated with the data center further based on:
determining a second power consumption of a different, second infrastructure device of the data center; and
estimating a second performance of the second infrastructure device based on the second power consumption.

5. The non-transitory computer-readable storage medium of claim 1, wherein the executable computer program instructions, when executed by the processor, cause the processor to determine the recommendation further based on:
identifying, based on operational data, a different, second infrastructure device estimated to have a greater carbon efficiency metric than the carbon efficiency metric associated with the data center.

6. The non-transitory computer-readable storage medium of claim 5, wherein the executable computer program instructions, when executed by the processor, cause the processor to determine the recommendation further based on:
determining that a capital expense of the second infrastructure device will be offset by an operational cost reduction associated with the second infrastructure device.

7. The non-transitory computer-readable storage medium of claim 1, wherein the recommendation identifies a second infrastructure device as suitable to replace the infrastructure device in the data center to improve the carbon efficiency metric.

8. The non-transitory computer-readable storage medium of claim 1, wherein the infrastructure device comprises a server, and wherein the recommendation identifies a workload suitable to be migrated from the server to a different, second server in the data center to improve the carbon efficiency metric.

9. A system, comprising:
a processor to perform processing of operations; and
a memory to store data, including operational data associated with one or more solutions, a time-series dataset associated with a data center, and instructions that, when executed, cause the processor to:
determine a carbon efficiency metric associated with the data center;
determine a recommendation to change the data center to improve the carbon efficiency metric based on:
identifying, based on the carbon efficiency metric and the operational data, a solution from the one or more solutions; and
predicting, using a machine learning model and based on the time-series dataset, whether the carbon efficiency metric is associated with a temporary event; and
provide the recommendation to an output device.

10. The system of claim 9, wherein the instructions, when executed, cause the processor to determine the recommendation further based on:
identifying, based on the operational data, a different, second solution from the one or more solutions,
wherein the recommendation comprises a priority of the solution and the second solution.

11. The system of claim 10, wherein the instructions, when executed, cause the processor to determine the recommendation further based on:
determining the priority of the solution and the second solution responsive to determining the carbon efficiency metric is associated with a temporary event.

12. The system of claim 9, wherein the system further comprises a server, and wherein the carbon efficiency metric associated with the data center comprises a carbon efficiency metric associated with the server.

13. The system of claim 9, wherein the time-series dataset comprises a trace of past carbon efficiency metrics associated with the data center over a period of time.

14. The system of claim 9, wherein the time-series dataset comprises a trace of past carbon efficiency metrics associated with a different data center over a period of time.

15. The system of claim 9, wherein the instructions, when executed by the processor, further cause the processor, to:
provide the recommendation to the output device responsive to predicting that the carbon efficiency metric is not associated with a temporary event.

16. The claim 9, wherein the instructions, when executed, further cause the processor to cause the processor to:
amend the recommendation responsive to predicting that the carbon efficiency metric is not associated with a temporary event; and
provide the recommendation to the output device responsive to amending the recommendation.

17. A method, comprising:
determining a current carbon efficiency metric of an infrastructure device in a heterogeneous data center based on:
determining a power consumption of the infrastructure device; and
estimating a performance of the infrastructure device based on the power consumption;
determining a recommendation to change the heterogeneous data center to improve the current carbon efficiency metric based on identifying, based on the current carbon efficiency metric and operational data associated with one or more solutions, a solution from the one or more solutions; and
providing the recommendation to improve the current carbon efficiency metric to an output device.

18. The method of claim 17, wherein the operational data comprises a mapping associated with the infrastructure device, and wherein estimating the performance comprises estimating the performance further based on the mapping.

19. The method of claim 17, wherein identifying the solution comprises:
determining, based on the operational data, that a carbon efficiency metric associated with the solution is greater than the current carbon efficiency metric.

20. The method of claim 17, further comprising:
predicting, based on the time-series dataset associated with the heterogeneous data center, whether a future carbon efficiency metric associated with the heterogeneous data center will satisfy a threshold;
determining a second recommendation to change the heterogeneous data center improve the future carbon efficiency metric; and
providing the second recommendation to the output device.
